(19) United States
(12) Patent Application Publication
(10) Pub. No.: US 2011/0139860 A1
(43) Pub. Date: Jun. 16, 2011

(54) Customizable and Printable Magnetic Structure

(76) Inventor: David J. Mueller, Mequon, WI (US)

(21) Appl. No.: 12/966,166

(22) Filed: Dec. 13, 2010

Related U.S. Application Data
(60) Provisional application No. 61/286,226, filed on Dec. 14, 2009.

(51) Int. Cl. B42D 15/02; B42D 15/00; G09F 3/04; G09F 3/02; B32B 38/14

(52) U.S. Cl. 229/92.8; 428/99; 156/277

(57) ABSTRACT

A magnetic structure for a mailer, postcard or other suitable device is provided. The structure includes a magnetic layer to which is secured a printable outer layer. The outer layer is formed of a material which can receive printed indicia thereon, as well as personalized handwritten indicia, to enable the structure to be customized by the sender or the recipient of the mailer structure.

### CROSS-REFERNECE TO RELATED APPLICATION

This application claims priority from U.S. Provisional Application Ser. No. 61/286,226, filed on Dec. 14, 2009, the entirety of which is hereby incorporated by reference herein.

### FIELD OF THE INVENTION

The present invention relates to material structures on which graphic and alphanumeric material can be printed in a suitable manner, and which is magnetized to be able to adhere to a metallic surface.

### BACKGROUND OF THE INVENTION

To disseminate information for advertising or other purposes, advertisements, such as mailers, inserts or postcards, among others, are often utilized to be sent out to numerous people. These advertisements are formed of suitable materials that can be printed on in any conventional manner, in order to enable the advertisements to be produced in large number using readily available printers of various types.

Further in certain circumstances, to enable the information printed and displayed on the advertisements to be presented in a readily accessible manner for the recipient, the advertisements can also be formed with a suitable magnetic component or layer. This enables the advertisements to be adhered to a metallic surface, such as a refrigerator, in a manner that places the advertisements and the information contained thereon in a readily viewable location for the recipient, such as a refrigerator. In structures of this type, the advertisement is formed with layers of material on one or both sides of a conventional magnetic layer, such that either one or both sides of the advertisements can be printed with the desired graphic or alphanumeric indicia.

However, it is desirable to develop a structure for an advertisement or similar item that can be magnetically adhered to a suitable surface, can have printed indicia placed thereon, and that can have various personalized messages placed thereon in a conventional manner.

### SUMMARY OF THE INVENTION

According to a one aspect of the present invention, a structure for an advertisement, such as a mailer, postcard or similar item is provided that includes a magnetic inner layer, and a pair of outer layers disposed on either side of the inner layer. The outer layers are formed from material(s) on which graphic or alphanumeric indicia can be printed using suitable conventional printing techniques. In addition one or both of the layers is formed of a material, such as, for example, a vinyl or lenticular paper material, that allows an individual to place personalized and/or handwritten messages on the outer layer.

According to another aspect of the present invention, the mailer can be manufactured and sold with various indicia printed thereon to illustrate where certain personalized information can beaded to the material, such as for a postcard or note card to be filled out and sent by an individual.

Numerous other aspects, features, and advantages of the present invention will be made apparent from the following detailed description together with the drawings figures.

### BRIEF DESCRIPTION OF THE DRAWINGS

The drawings illustrate the best mode currently contemplated of practicing the present invention.

In the drawings:

FIG. 1 is an isometric view of an advertisement structure constructed according to the present disclosure;

FIG. 2 is a cross-sectional view along line 2-2 of FIG. 1;

FIG. 3 is a rear isometric view of the advertisement of FIG. 1; and

FIG. 4 is a cross-sectional view of an advertisement structure constructed according to the present disclosure.

### DETAILED DESCRIPTION OF THE INVENTION

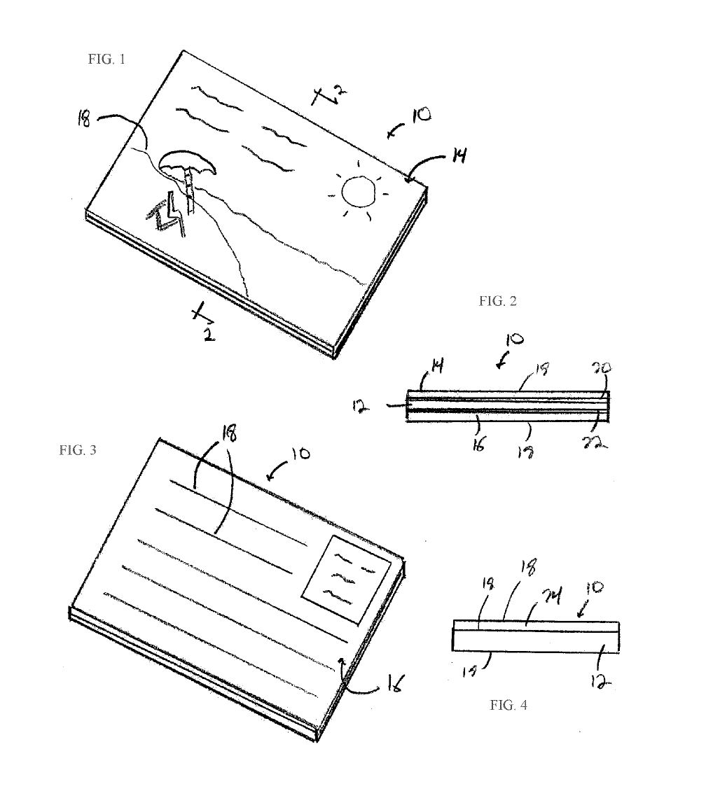

With reference now to the drawing figures in which like reference numerals designate like parts throughout the disclosure, a structure for use as an advertisement, a mailer, a postcard, etc, is indicated generally at 10 in FIGS. 1-3. In one embodiment, the structure 10 includes an inner layer 12 and a pair of outer layers 14, 16.

The inner or base layer 12 may be made using a magnetic material. The layer 12 may be formed in any conventional and well known manner using a suitable material, such as a single layer of a vinyl or paper or as a combination of materials or layers bonded together to form the layer 12. The layer 12 may be magnetized by including a number of ferromagnetic or magnetized particles distributed in the layer 12 causing the layer to exhibit magnetic properties (such as affixing the structure 10 to a magnetic receptive surface). The inner layer 12 can be provided with these magnetic properties either before or after creation or lamination in the advertisement 10.

The outer layers 14, 16 are affixed to the inner layer 12 in any suitable manner, such as, for example, using an adhesive applied to the inner layer 12 to bond or affix the outer layers 14, 16 to opposite sides of the layer 12.

Each of the outer layers 14, 16 are formed of a material that is receptive to printing in various printing processes, such as, for example, silk screening, sheet fed or web offset printing, web letter press printing, gravure printing, and/or inkjet or laser printing. The printed material 18 placed on one or both of the outer printable layers 14, 16 may include text and/or graphics. For example, the printed material 18 may include one or more of a logo, a symbol, an icon, a design, a picture, an emblem, a line, a pattern, a graphical depiction, and/or an image. The printed material 18 also may include numbers, characters, trademarks, trade names, service marks, and other business information.

Further, at least one of the outer layers 14, 16 is formed at least partially of a material that not only is capable of receiving the printed material 18 thereon, but that also can receive personalized writings or other markings made by an individual, including, for example, characters, symbols, numbers, marks, hole-punches and other indications. To provide this feature, one or both of the outer layers 14,16 is made of or coated with a material receptive to marking, such as, for example, polyvinyl, LEXAN, MYLAR, and/or DURA-LAR. In one embodiment, the printed material 18 is applied to one or both of the outer layers 14, 16 prior to the application of a coating 24 to the exterior of the layers 14, 16 that facilitates the application of the personalized material to the structure 10.

With this structure for the structure 10, the outer layers 14, 16 can be printed in a suitable manner with the desired information or graphics to be presented on the structure 10, such as business information, or a photo and accompanying mailing and writing indicia for use of the mailer 10 as a postcard. Once printed, the structure 10 can be personalized as desired by the sender and/or recipient of the structure 10 by writing or placing other characters directly on one or both of the outer layers 14, 16 in a location indicated by the printed material 18 on the layers 14,16.

In alternative embodiments, it is contemplated that one of the outer layers 14,16 can be omitted, or the both outer layers 14,16 can be omitted with the inner layer 12 being formed from a suitable material having magnetic properties, and optionally a coating 24 thereon, as shown in FIG. 4. The printed material 18 can be disposed on either the inner layer 12 or the coating 24, with the coating 24 being able to receive the personalized writing thereon. Additionally, one or both of the outer layers 14, 16 can remain on the structure 10, with printed material 18 disposed on the inner layer 12 and optionally on the outer layers 14, 16.

Additionally, as shown in FIG. 3, the structure 10 can include a pair of film layers 20, 22 disposed on opposed sides of the structure 10. These layers 20, 22 enable the structure for the structure 10 to more easily be formed into rolls, which can subsequently be stored and cut into the desire shapes for the structure 10. In one embodiment, the layers 20, 22 are positioned between the magnetic material 12 and the layers 14, 16, and are formed from suitable plastics or papers.

Various other embodiments of the present invention are contemplated as being within the scope of the filed claims particularly pointing out and distinctly claiming the subject matter regarded as the invention.

1. A laminate structure comprising:
a) a magnetic layer; and
b) at least one printable layer secured to one side of the magnetic layer and receptive to printed and handwritten indicia.

2. The laminate structure of claim 1 further comprising a first printable layer on one side of the magnetic layer.

3. The laminate structure of claim 2 further comprising a second printable layer disposed on the magnetic layer opposite the first printable layer.

4. The laminate structure of claim 1 wherein the at least one printable layer is secured to the magnetic layer by an adhesive.

5. The laminate structure of claim 1 further including printed material on the at least one printable layer for use of the mailer as a postcard.

6. The laminate structure of claim 1 further including a coating disposed on the at least one printable layer opposite the magnetic layer.

7. A method of preparing a personalizable magnetic material, the method comprising the steps of:
a) preparing a base layer having a magnetizable material therein;
b) placing a printable layer on at least one side of the base layer; and
c) printing indicia on the printable layer.

8. The method of claim 7 further comprising the step of placing a coating layer over the printable layer.

9. The method of claim 8 further comprising the step of placing personalized printed material on the coating layer.

10. A laminate structure consisting essentially of:
a) a base layer having a magnetizable material therein;
b) a first outer, printable layer adapted to receive printed and handwritten indicia thereon affixed to the base layer.

11. The laminate structure of claim 10 further consisting essentially of a first roll-forming film layer disposed between and affixed to the base layer and the first outer layer.

12. The laminate structure of claim 10 further consisting essentially of a coating affixed to the first outer layer opposite the base layer.

13. The laminate structure of claim 12 further consisting essentially of printed material disposed between the first outer layer and the coating.

14. The laminate structure of claim 10 further consisting essentially of a second outer printable layer affixed to the base layer opposite the first outer printable layer.

15. The laminate structure of claim 14 further consisting essentially of a second roll-forming film layer disposed between and affixed to the base layer and the second outer layer.

16. The laminate structure of claim 10 further consisting essentially of printed material disposed on the base layer between the base layer and the first outer layer.

17. The laminate material of claim 10 further consisting essentially of printed material disposed on the first outer layer opposite the base layer.
